(19) United States
(12) Patent Application Publication
(10) Pub. No.: US 2015/0221964 A1
(43) Pub. Date: Aug. 6, 2015

(54) FREEZE START-UP METHOD FOR FUEL CELL SYSTEM

(71) Applicants: Daimler AG, Stuttgart (DE); Ford Motor Company, Dearborn, MI (US)

(72) Inventor: Richard Fellows, Vancouver (CA)

(21) Appl. No.: 14/606,067

(22) Filed: Jan. 27, 2015

Related U.S. Application Data
(60) Provisional application No. 61/934,743, filed on Feb. 1, 2014.

(51) Int. Cl. H01M 8/04

(52) U.S. Cl. CPC H01M 8/04268

(57) ABSTRACT

Methods are disclosed for starting up a fuel cell system from subzero temperatures using the latent heat of crystallization available in a water supply maintained at above freezing temperature. During start-up, a water spray subsystem is used to spray water from the supply onto a heat exchange surface in a heat exchange element through which coolant from a fuel cell stack coolant circuit is circulating. The water freezes onto the heat exchange surface and the heat of crystallization is exchanged with the circulating coolant across the heat exchange surface, thus warming the coolant.

### FIELD OF THE INVENTION

This invention relates to methods for starting up a fuel cell system at below freezing temperatures. In particular, it relates to methods for starting up an automotive fuel cell system comprising a solid polymer electrolyte fuel cell stack.

### DESCRIPTION OF THE RELATED ART

Fuel cells such as solid polymer electrolyte or proton exchange membrane fuel cells electrochemically convert reactants, namely fuel (such as hydrogen) and oxidant (such as oxygen or air), to generate electric power. Solid polymer electrolyte fuel cells generally employ a proton conducting, solid polymer membrane electrolyte between cathode and anode electrodes. A structure comprising a solid polymer membrane electrolyte sandwiched between these two electrodes is known as a membrane electrode assembly (MEA). In a typical fuel cell, flow field plates comprising numerous fluid distribution channels for the reactants are provided on either side of a MEA to distribute fuel and oxidant to the respective electrodes and to remove by-products of the electrochemical reactions taking place within the fuel cell. Water is the primary by-product in a cell operating on hydrogen and air reactants. Because the output voltage of a single cell is of order of 1V, a plurality of cells is usually stacked together in series for commercial applications in order to provide a higher output voltage. Fuel cell stacks can be further connected in arrays of interconnected stacks in series and/or parallel for use in automotive applications and the like.

Along with water, heat is a significant by-product from the electrochemical reactions taking place within the fuel cell. Means for cooling a fuel cell stack is thus generally required. Stacks designed to achieve high power density (e.g. automotive stacks) typically circulate liquid coolant throughout the stack in order to remove heat quickly and efficiently. To accomplish this, coolant flow fields comprising numerous coolant channels are also typically incorporated in the flow field plates of the cells in the stacks. The coolant flow fields may be formed on the electrochemically inactive surfaces of the flow field plates and thus can distribute coolant evenly throughout the cells while keeping the coolant reliably separated from the reactants.

Various subsystems and methods have been disclosed in the art for purposes of improving the cooling performance in such stacks. For instance, CA2424172 discloses a fuel cell system with a heat exchange unit coupled to the coolant inlet and exhaust. A water spraying unit is also included for spraying exhaust water into air blown through the heat exchange unit. Exhaust water is evaporated and increases the cooling performance of the heat exchange unit.

In certain applications, PEMFC stacks may be subjected to repeated on-off duty cycles involving storage for varied lengths of time and at varied temperatures. It is generally desirable to be able to reliably start-up such stacks in a short period of time. Certain applications, like automotive, can require relatively rapid reliable start-up from storage conditions well below freezing. This has posed a significant challenge both because of the relatively low rate capability of cells at such temperatures and also because of problems associated with water management in the cells when operating below 0° C. A certain amount of water is required for proper fuel cell operation (e.g. hydration of the membrane electrolyte) and is generated as a result of providing electrical power. However, ice of course forms where liquid water is present at such temperatures. The presence of ice can be problematic depending on how much there is and its location when stored or when starting up.

Various fuel cell designs and start-up methods have been developed in the art to provide for improved start-up from temperatures below freezing. For instance, JP2005251463 discloses a method for starting up a fuel cell system at low temperature using a heat generating means where heat is obtained from the heat of solidification of sodium acetate trihydrate. Water frozen in the fuel cell stack is thawed with a small power consumption by starting the heat generating means prior to starting up the stack.

Despite the advances made to date, there remains a need for simpler and effective methods for starting up fuel cell systems from subzero temperature. This invention represents an option for fulfilling these needs and provides further related advantages.

### SUMMARY

As part of the process for starting up a fuel cell system from subzero temperatures, one can use the latent heat of crystallization available in a water supply maintained at above freezing temperature. During start-up, a water spray subsystem is used to spray water from the supply onto a heat exchange surface in a heat exchange element through which coolant from a fuel cell stack coolant circuit is circulating. The water freezes onto the heat exchange surface and the heat of crystallization is exchanged with the circulating coolant across the heat exchange surface, thereby warming the coolant and hence the fuel cell stack. In an automotive fuel cell system, a modestly sized water supply can surprisingly provide a substantial amount of the heat desired for start-up purposes.

In the present invention, the fuel cell system comprises a fuel cell stack, a coolant circuit configured to circulate coolant through the fuel cell stack, and a heat exchange element in the coolant circuit in which the heat exchange element comprises a heat exchange surface and coolant flows on one side of the heat exchange surface. The system further comprises a container comprising a supply of water, and a water spray subsystem configured to obtain water from the water supply in the container and to spray the water onto the other side of the heat exchange surface. Specifically then, the method for starting up such a fuel cell system from a temperature below freezing comprises maintaining the supply of water at above freezing temperature prior to starting up, circulating coolant through the coolant circuit (and hence the fuel cell stack and the heat exchange element), obtaining water from the water supply in the container, and spraying the water onto the other side of the heat exchange surface while the fuel cell system is at a temperature below freezing. As a result of the method, water freezes onto the heat exchange surface and the heat of crystallization is exchanged with the circulating coolant across the heat exchange surface thereby warming the coolant.

During the starting up, a starting amount of power can be drawn from the fuel cell stack while the fuel cell system is at a temperature below freezing. Alternatively, the drawing of power may be postponed until the system is above freezing to avoid creating water in the stack from the electrochemical reactions taking place therein.

In order to maintain the supply of water at above freezing temperature prior to starting up, the water supply container is well insulated thermally (e.g. vacuum jacketed container). Further, the fuel cell system can include an electric heater in thermal contact with the supply of water. Heat from the electric heater can thus be used to keep the water supply above freezing.

In one embodiment, the water spray subsystem is also maintained at above freezing temperature prior to starting up. This too can be achieved using the electric heater mentioned above (or another heater) if configured to be in adequate thermal contact with the water spray subsystem.

In an alternative embodiment, the water spray subsystem can be allowed to fall to the same subzero temperature as the rest of the fuel cell system. Here however, the water spray subsystem may be emptied of water prior to subjecting the fuel cell system to below freezing temperature. In this way, no water is present to freeze in the water spray subsystem prior to starting up.

The water spray subsystem can comprise a water pump and a spray nozzle. The water pump may desirably be self-priming, particularly in embodiments where the water spray subsystem is occasionally emptied of water.

The method of the invention is generally suitable for use in systems comprising solid polymer electrolyte fuel cell stacks. For instance, the method may be considered for use in an air cooled fuel cell system which typically employs a solid polymer electrolyte fuel cell stack. In such an air cooled option, ambient air is typically obtained and used as both the oxidant and coolant. When using the present method, the heat exchange element here could be the oxidant/coolant passages in the air cooled fuel cell system. The method however is particularly suitable for use in automotive fuel cell systems, in which aqueous antifreeze liquid coolants are typically employed.

In an automotive embodiment, an adequate amount of latent heat for starting up may be expected from a water supply comprising greater than or about 0.03 liters of water per kW of power capability from the fuel cell stack. And in certain practical embodiments, the supply of water can comprise less than or about 2 liters of water.

Often, automotive fuel cell systems may already comprise elements in their cooling circuit that can serve as adequate heat exchange elements for the present method. Such elements may need little to no modification to accommodate a suitable water spray subsystem. Alternatively, an element may be introduced into the cooling circuit for purposes of the present method.

Elements that often appear in cooling circuits and which may serve as heat exchange elements include: a contact humidifier, an intercooler, and/or a radiator. Typically, a contact humidifier is located both in the coolant circuit and in an oxidant inlet of the fuel cell stack. An intercooler may be employed in fuel cell systems comprising an air compressor for providing compressed air to an oxidant inlet of the fuel cell stack. The intercooler is located between the air compressor and the oxidant inlet. A radiator is located at a suitable location in the coolant circuit to shed heat to the environment.

In a like manner, the fuel cell system may contain elements which may serve in part as a water supply, container, and/or water spray subsystem for the present method. For instance, as illustrated below, a fuel cell system comprising a U-tube filled with water may be employed to provide a low pressure seal of an oxidant outlet of the system's fuel cell stack. The water supply, container, and water spray subsystem of the present invention can be integrated elegantly into such an arrangement, without much modification to the fuel cell system.

These and other aspects of the invention are evident upon reference to the attached Figure and following detailed description.

### BRIEF DESCRIPTION OF THE DRAWINGS

FIG. 1 is a schematic of an exemplary automotive fuel cell system which can be started up from a temperature below freezing using the method of the invention.

### DETAILED DESCRIPTION

In this specification, words such as “a” and “comprises” are to be construed in an open-ended sense and are to be considered as meaning at least one but not limited to just one.

Herein, in a quantitative context, the term “about” should be construed as being in the range up to plus 10% and down to minus 10%.

The method of the invention uses the latent heat of crystallization available in a water supply maintained at above freezing temperature to assist in heating and thus starting up a fuel cell system from temperatures below freezing. Water from the supply is sprayed onto an appropriate heat exchange surface in a heat exchange element or elements through which coolant from a fuel cell stack coolant circuit is circulating. The water freezes onto the heat exchange surface and the heat of crystallization is exchanged with the circulating coolant across the heat exchange surface, thus warming or significantly assisting in warming the coolant and starting up the fuel cell system.

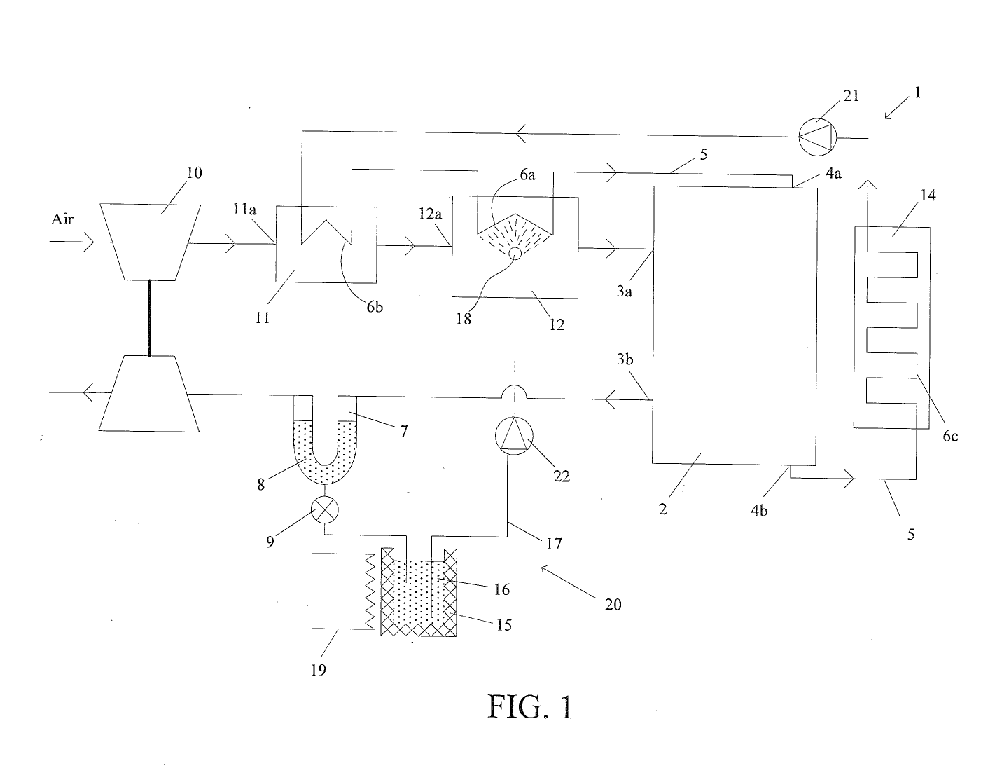

An exemplary automotive fuel cell system which can be started up using the method of the invention is schematically shown in FIG. 1. As shown, fuel cell system 1 includes fuel cell stack 2 which comprises a series stack of solid polymer electrolyte fuel cells. Ambient air is used as the supply of oxidant and is compressed by compressor 10 and delivered to oxidant inlet 3a of fuel cell stack 2. This air can be heated substantially as a result of the compression and, if so heated, it is first cooled by being directed through intercooler 11 (at inlet 11a), and then directed to contact humidifier 12 (at inlet 12a) where it is humidified before finally being delivered to fuel cell stack 2. Oxygen-depleted air and by-product water vapour and liquid water is exhausted from fuel cell stack 2 at oxidant outlet 3b. The system shown in FIG. 1 employs an optional U-tube 7 filled with liquid water 8 to serve as a simple, low pressure seal for the stack's oxidant outlet 3b when the stack is shut down and not operating. Water may be admitted to or drained from U-tube 7 through valve 9. After passing through U-tube 7, the oxidant exhaust is used to drive compressor 10 and is then exhausted to the environment. (The fuel supply, inlets and outlets, and typical recirculation hardware in the fuel cell system have been omitted from FIG. 1 for simplicity.)

The cells in fuel cell stack 2 comprise coolant flow fields (not shown) which are appropriately connected to coolant manifolds (not shown) within stack 2. During normal operation, circulating coolant is used to remove heat generated within the stack. When starting from below freezing temperature, the circulating coolant may be used to heat stack 2 if the coolant is heated externally. The coolant employed is typically an aqueous solution comprising an appropriate antifreeze liquid (e.g. ethylene glycol), and which is capable of tolerating the lowest expected ambient temperatures without freezing.

Coolant is provided to stack 2 at coolant inlet 4a, circulated within, and then removed at coolant outlet 4b. The coolant circulates external to stack 2 through coolant circuit 5. Coolant pump 21 is used to drive the circulating coolant. During normal operation, coolant heated within stack 2 is directed to radiator 14, where heat is shed to the environment at heat exchange surface 6c. Then, as shown in FIG. 1, the coolant is directed to intercooler 11 where it is used to cool incoming air if it had been heated substantially as a result of compression in compressor 10. The surface where incoming air is cooled and heat exchange occurs in intercooler 11 is shown as heat exchange surface 6b. Coolant is next directed to contact humidifier 12 which is used to humidify the incoming air coming from intercooler 11. In contact humidifier 12, humidification is provided by spraying water or water vapour directly into the incoming air stream and/or onto a heated surface where it vaporizes. As shown in FIG. 1, surface 6a is provided in coolant circuit 5 within contact humidifier 12 and serves as a heated surface for humidification purposes during normal operation and as heat exchange surface 6a during start-up in the present invention.

Fuel cell system 1 additionally includes water spray subsystem 20 comprising thermally insulated container 15 (e.g. vacuum jacketed container) which contains a supply of water 16 that is maintained at above freezing temperature. Spray line 17 is located in container 15 in order to access water supply 16. Self-priming pump 22 is provided in spray line 17 to pump water from supply 16 to spray nozzle 18 located within contact humidifier 12. As depicted, spray nozzle 18 is configured to spray water onto heat exchange surface 6a for purposes of starting up system 1 in accordance with the invention. However, if appropriately configured as schematically shown in FIG. 1, water spray from spray nozzle 18 might also be used as humidification water, or in addition to humidification water provided by other means, for contact humidifier 12 during normal operation. In addition, electric heater 19 is provided to be in thermal contact with container 15 and water supply 16.

During normal operation, fuel cell stack 2 typically runs at temperatures well above ambient (e.g. 80° C.). Coolant pump 21 pumps antifreeze liquid so that it circulates in cooling circuit 5 and removes heat generated in fuel cell stack 2. This heat is then shed from the coolant to the environment via radiator 14. The radiator-cooled coolant is then used in intercooler 11 to remove excessive heat (if present as a result of compression) from the incoming oxidant air. The coolant exiting intercooler 11 then enters contact humidifier 12 and is directed across heat exchange surface 6a. Here, the coolant is used to heat the water being sprayed on heat exchange surface 6a, thus assisting to vaporize the water and humidify the incoming oxidant air. After exiting contact humidifier 12, the coolant is directed back to fuel cell stack 2.

Further, during normal operation, water supply 16 serves as a water supply for humidification in contact humidifier 12. Liquid water 8 in U-tube 7 only provides a modest back pressure or restriction to the flow of oxidant exhaust from oxidant outlet 3b.

If fuel cell system 1 is to be shutdown, stored, and/or started up at temperatures above freezing, pump 22 is typically turned off However, liquid water 8, water supply 16, and the remainder of water spray subsystem 20 may be left as is, and electric heater 19 need not be employed. In this situation, liquid water 8 in U-tube 7 provides a low pressure seal for oxidant outlet 3b and prevents ambient air from entering fuel cell stack 2.

However, if fuel cell system 1 is expected to experience subzero temperatures when shutdown, stored, and/or started up, steps are taken to prevent water freezing in U-tube 7 and water spray subsystem 20 prior to these events. For instance, as shown in FIG. 1, liquid water 8 may be drained via valve 9 into container 15 and thus prevent water freezing in U-tube 7. (Of course, U-tube 7 now no longer serves to seal oxidant outlet 3b from the environment. If this is not acceptable, other means may need to be employed to seal oxidant outlet 3b.) Further, water may be drained from spray nozzle 18, self-priming pump 22 and spray line 17 into container 15. All this drained water and the rest of water supply 16 are maintained above freezing temperature with heat provided by electric heater 19. Appropriate temperature sensing and control hardware (not shown) could be used to ensure water supply 16 does not freeze without using excessive electrical energy.

In the embodiment shown in FIG. 1, coolant humidifier 12 serves as the heat exchange element for purposes of the invention. During start-up from subzero temperature, coolant pump 21 is started and coolant is again circulated through coolant circuit 5 and thus through fuel cell stack 2. Coolant also flows on one side of heat exchange surface 6a in contact humidifier 12. Self-priming pump 22 is also started and water at above freezing temperature is pumped from liquid water supply 16 and sprayed from spray nozzle 18 onto heat exchange surface 6a. The sprayed water freezes onto heat exchange surface 6a and the heat of crystallization is exchanged with the circulating coolant, thereby warming it. In turn, the warmed coolant is then directed to coolant inlet 4a where it now heats fuel cell stack 2.

The method is then continued until the coolant and fuel cell stack 2 have reached almost zero degrees after which, for instance, heat from operation of fuel cell stack 2 can bring the rest of the system above freezing and up to normal operating temperature. Thus, a starting amount of power may be drawn from fuel cell stack 2 while the system is just below freezing.

Although FIG. 1 and the preceding description illustrate one possible embodiment of the invention, those skilled in the art will appreciate that other system arrangements and/or other start-up procedures may be considered. For instance, the heat exchange element used during start-up may be, or may additionally include, intercooler 11, radiator 14, or an additional dedicated element in the system. In such a case, water spray subsystem 20 would be configured to spray water onto surfaces 6b, 6c, and/or an appropriate surface in the additional dedicated element (not shown). Further, optional U-tube 7 need not be employed. Further still, electric heater 19, or an additional electric heater, may be configured to also heat the rest of water spray subsystem 20 such that water need not be drained therefrom and also allowing for the use of a pump 22 that is not self-priming. And even further, additional heat for start-up purposes may be obtained via other means known to those in the art. Thus, for instance, power need not be drawn from fuel cell stack 2 until after it has reached an above freezing temperature.

Surprisingly perhaps, calculations show that a modest amount of water can be expected to provide an adequate amount of latent heat for starting up a typical automotive fuel cell stack. For example, a water supply comprising greater than or about 0.03 liters of water per kW of power capability from the fuel cell stack, and maintained above freezing may have an adequate amount of latent heat. In certain practical embodiments then, the supply of water can comprise less than or about 2 liters of water.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. For instance, while the preceding description was mainly directed at liquid cooled fuel cell systems, it is possible to consider using the disclosed methods for air cooled or other fuel cell systems as well. Such modifications are to be considered within the purview and scope of the claims appended hereto.

What is claimed is:

1. A method for starting up a fuel cell system from a temperature below freezing, the fuel cell system comprising a fuel cell stack; a coolant circuit configured to circulate coolant through the fuel cell stack; a heat exchange element in the coolant circuit wherein the heat exchange element comprises a heat exchange surface and coolant flows on one side of the heat exchange surface; a container comprising a supply of water; a water spray subsystem configured to obtain water from the water supply in the container and to spray the water onto the other side of the heat exchange surface, and the method comprising:
maintaining the supply of water at above freezing temperature prior to starting up;
circulating coolant through the coolant circuit, the fuel cell stack, and the heat exchange element;
obtaining water from the water supply in the container; and
spraying the water onto the other side of the heat exchange surface while the fuel cell system is at a temperature below freezing.

2. The method of claim 1 wherein water freezes onto the heat exchange surface and the heat of crystallization is exchanged with the circulating coolant across the heat exchange surface thereby warming the coolant.

3. The method of claim 1 comprising:
drawing a starting amount of power from the fuel cell stack while the fuel cell system is at a temperature below freezing.

4. The method of claim 1 wherein the fuel cell system comprises an electric heater in the mal contact with the supply of water and the method comprises maintaining the supply of water at above freezing temperature using heat from the electric heater prior to starting up.

5. The method of claim 1 comprising:
maintaining the water spray subsystem at above freezing temperature prior to starting up.

6. The method of claim 1 comprising:
emptying water from the water spray subsystem prior to subjecting the fuel cell system to below freezing temperature.

7. The method of claim 1 wherein the water spray subsystem comprises a water pump and a spray nozzle.

8. The method of claim 7 wherein the water pump is self-priming.

9. The method of claim 1 wherein the supply of water comprises greater than or about 0.03 liters of water per kW of power capability from the fuel cell stack.

10. The method of claim 1 wherein the supply of water comprises less than or about 2 liters of water.

11. The method of fuel cell system of claim 1 wherein the fuel cell stack is a solid polymer electrolyte fuel cell stack.

12. The method of claim 11 wherein the fuel cell system is an automotive fuel cell system.

13. The method of claim 12 wherein the heat exchange element is a contact humidifier located both in the coolant circuit and in an oxidant inlet of the fuel cell stack.

14. The method of claim 12 wherein the fuel cell system comprises an air compressor for providing compressed air to an oxidant inlet of the fuel cell stack, and the heat exchange element is an intercooler located between the air compressor and the oxidant inlet.

15. The method of claim 12 wherein the heat exchange element is a radiator located in the coolant circuit of the fuel cell stack.

16. The method of claim 1 wherein the coolant is an antifreeze liquid.

17. The method of claim 1 wherein the container is thermally insulated.
